(19) United States
(12) Patent Application Publication
(10) Pub. No.: US 2020/0255276 A1
(43) Pub. Date: Aug. 13, 2020

(54) SYSTEM AND METHOD FOR AUTOMATIC FLUID DISPENSING

(71) Applicant: Tianzhi Yang, San Jose, CA (US)

(72) Inventor: Tianzhi Yang, San Jose, CA (US)

(21) Appl. No.: 16/274,852

(22) Filed: Feb. 13, 2019

(51) Int. Cl. B67D 1/08; B67D 1/00; B67D 1/12

(52) U.S. Cl. CPC B67D 1/0882; B67D 1/0085; B67D 2210/00141; B67D 1/1202; B67D 2001/0094; B67D 1/0888

(57) ABSTRACT

An embedded system controls an electric fluid valve, and the embedded system is connected to and receives overlooking images from an overlooking camera. It processes the images using a sequence labeling unit to tell if a fluid container is ready to receive and operates the valve accordingly.

### CROSS-REFERENCE TO RELATED APPLICATIONS

This application claims the benefit of U.S. Provisional Application No. 62/641,351 filed Mar. 11, 2018 by the present inventor.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND-PRIOR ART

### U.S. Patents

| Patent Number | Kind Code | Issue Date | Patentee |
|---|---|---|---|
| 4,972,070 | A | 1990 Nov. 20 | Laverty |
| 5,508,510 | A | 1996 Apr. 16 | Laverty |
| 5,632,414 | A | 1997 May 27 | Merriweather |
| 7,069,941 | B2 | 2006 Jul. 04 | Parsons et al. |

### U.S. Patent Application Publications

| Publication Number | Kind Code | Publ. Date | Applicant |
|---|---|---|---|
| 20090178728 | A1 | Jul. 16, 2009 | Cochran et al. |
| US 2015/0315008 | A1 | Nov. 5, 2015 | Locke et al. |
| US2018/014891 | A1 | May 31, 2018 | Park |

### Nonpatent Literature Documents

Chris@BCR. Jul. 2, 2015. Controlling a solenoid valve with arduino. https://www.bc-robotics.com/tutorials/controlling-a-solenoid-valve-with-arduino/. (Accessed: 2019-02-13)

The present disclosure relates to the automatic operating of fluid dispensers. Sometimes a user presses a button to start dispensing, and releases the button to suspend. Some fluid dispensers are equipped with infrared sensors so that fluid dispensing can automatically start when it is detected that a fluid container is getting close, and it suspends when the container is removed. However my experiences show that such systems are sensitive to the orientations of the reflecting surfaces and the lighting conditions.

### DRAWINGS—FIGURES

FIG. 1 is a side view of some inner components of an exemplary fluid dispenser comprising an embodiment of this invention.

FIG. 2 is an orthogonal view of the fluid dispenser shown in FIG. 1.

FIG. 3 is a side view of some inner components of another exemplary fluid dispenser comprising another embodiment of this invention.

FIG. 4 is a flow chart of an exemplary process for automatically operating fluid dispensing according to one embodiment.

FIG. 5 shows example training images for the “not present” class according to one embodiment of this invention.

FIG. 6 shows example training images for the “off center” class according to one embodiment of this invention.

FIG. 7 shows example training images for the “receiving” class according to one embodiment of this invention.

FIG. 8 shows example training images for the “tilting” class according to one embodiment of this invention.

FIG. 9 shows one example output of using a sequence labeling unit comprising an object detection neural work to detect fluid containers with the “Up Cup” class.

FIG. 10 shows another example output of using a sequence labeling unit comprising an object detection neural work to detect fluid containers with the “Tilt Cup” class.

FIG. 11 illustrates an exemplary embedded system.

FIG. 12 illustrates an exemplary sequence labeling unit.

### DETAILED DESCRIPTION

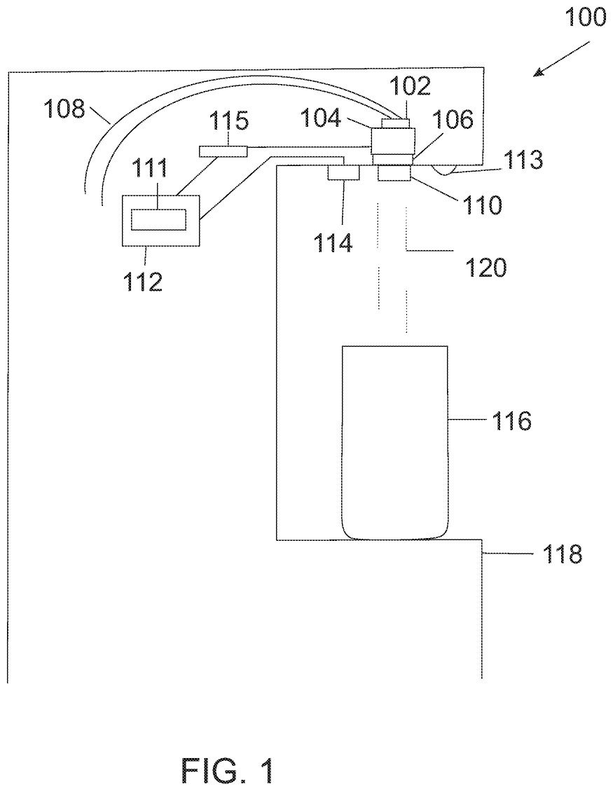

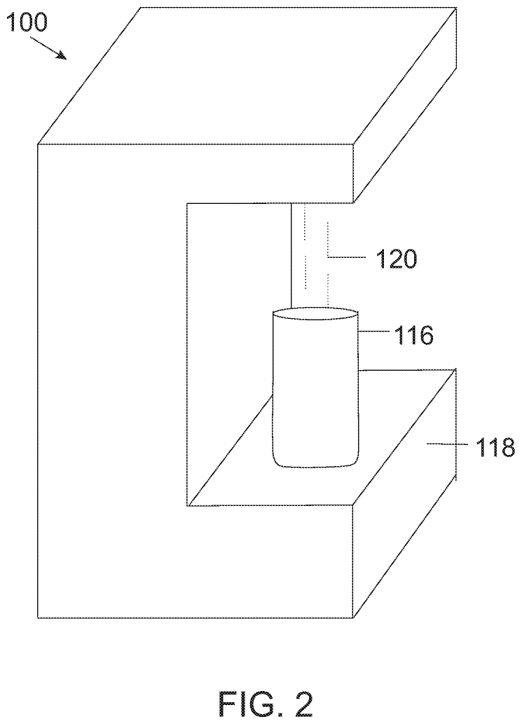

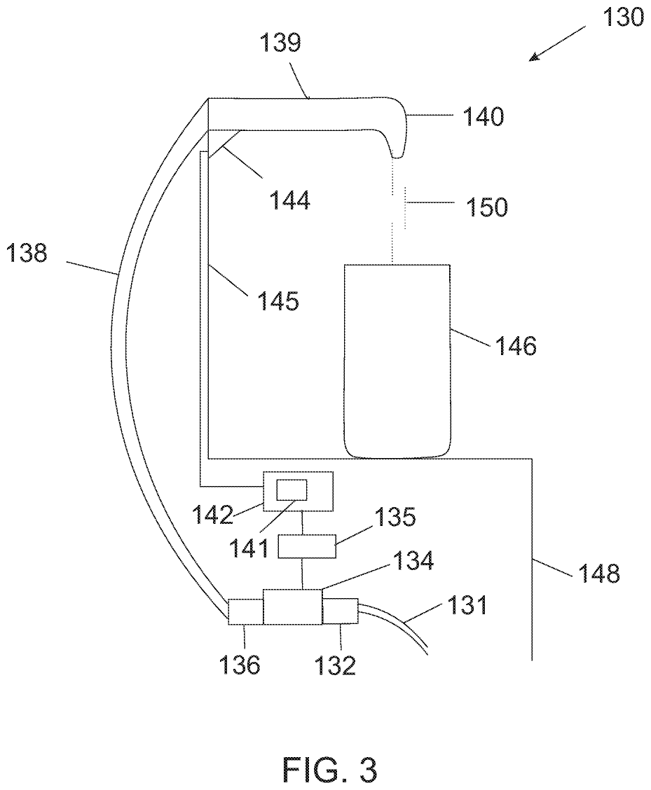

An overlooking camera is a camera module mounted near a spout, so that when a fluid container is placed on a receiving area under the spout to receive fluid, the camera module can capture a substantial portion of the fluid container. For example, in FIG. 1, an overlooking camera 114 is mounted adjacent to sprout 110. In FIG. 3, an overlooking camera 144 is not amounted directly on top of a drink container 146. In this document, I'll refer to the images that are captured by an overlooking camera overlooking images.

FIG. 1 is a side view of the inner components of an exemplary fluid dispenser comprising an embodiment of this invention. A solenoid valve 104 is mounted inside a fluid dispenser 100. Valve 104 has an inlet 102 that is connected to a pipe 108, and an outlet 106 that is connected to a spout 110. fluid flows into inlet 102 with a certain pressure so that it can flow through valve 104, outlet 106, and spout 110 when valve 104 is turned on, and it is suspended when valve 104 is turned off. The connections between the inlet and the source, and the connection between the outlet and the spout does not need to be direct, i.e., there can be other components for example water filters or more pipes, etc. and Alternatively other types of electrically operated valves can also be used, for example an electrical motor valve. In some embodiments mixing valves with two or more inlets could also be used. For illustration purpose, FIG. 1 also shows a fluid container 116 placed on a base 118 beneath spout 110 so that it can receive fluid 120.

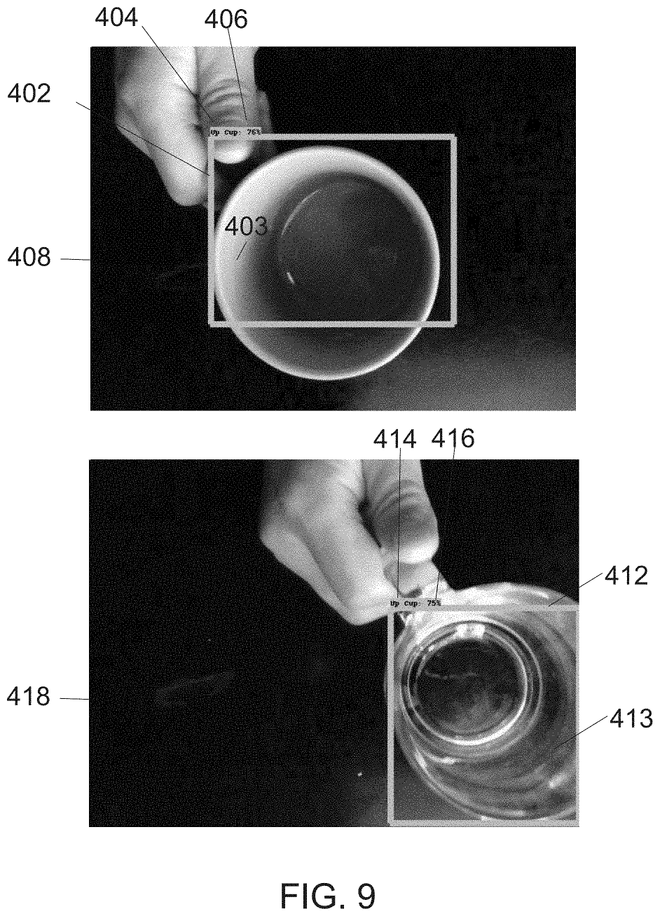

FIG. 1 also shows an optional overlooking light 113 that is mounted near spout 110 for reducing the impact of variations of lighting conditions in different working environments. An overlooking light can cast a shadow that can be used to help detection. For example referring to FIG. 9, in image 408, a light source from the up right direction casts a shadow on the bottom and the right half of the inner wall of cup 403. If an embodiment is to be deployed to environments where the lighting conditions cannot be predicted, for example when there is no overlooking light or if the ambient lighting is very strong, the neural networks in the sequence labeling unit described below needs to be trained with overlooking images from various common lighting conditions.

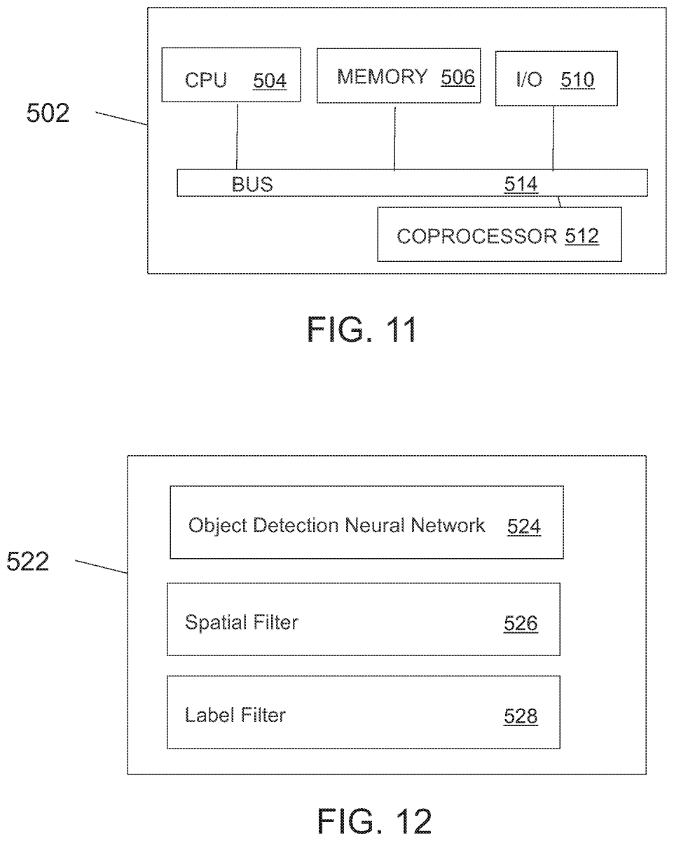

FIG. 1 also shows an embedded system 112 mounted inside the fluid dispenser. Referring to FIG. 11, it shows an exemplary embedded system 502 that comprises a processor unit 504, a memory module 506, a buses component 514, and an input/output module 510. It further comprises an optional coprocessor 512. The coprocessor is used to speed up the computation of artificial neural networks described below. For example, the NVIDIA TX2 contains CUDA cores that are capable of doing inferencing at real time. Other suitable coprocessors include Google's TPU (Tensor processing units), and ASICs specific designed for neural network computing such as the Intel Movidius VPUs, etc. Support for hardware accelerators are usually expected to be included in the framework a user chooses, thus one is not expected to deal with low level details except for certain high level configurations.

Embedded system 112 receives overlooking images from an overlooking camera 114. Different kinds of cameras could be used. In one embodiments a color camera is used that takes RGB images, alternatively monochrome cameras could also be used, or fish-eye cameras can be used to increase the captured area. They can be connected through standard interfaces for example USB, FireWire, or CSI (Camera Serial Interface) etc.

When an overlooking camera's image plane is not parallel to the base surface that fluid containers sit on, curves of the same length will looking shorter or longer depending on their relative locations to the camera, a phenomena called the perspective effect. A perspective transformation can be computed using points correspondences. It can be applied to warp input overlooking images to reduce distortions due to the perspective effect. Furthermore, some algorithms can automatically detect source and destination points using feature points detection techniques.

Besides the perspective transformation, various other preprocessing techniques can be applied. Examples include normalization, crop, and color space conversion, etc. Typical color space conversions include RGB to HSV, RGB to HLS, and others. (This is not necessary if we are using a monochrome camera.). Some of the resulting channels represent brightness, while others are related to color. Channels representing brightness are expected to help neural network detection using shadows as features. Thus the overlooking lights mentioned earlier could also help. After conversion, in some embodiments we can selectively pass certain color channels to the next stages of detection. For example, in one situation we convert from the RGB to the HSV color space, and pass all channels, in another example we can compute the L channel and pass only this channel into the sequence labeling unit. In some other embodiments we can choose to keep all input channels.

Embedded system 112 then runs a sequence labeling unit 111. A sequence labeling unit receives overlooking images, and its output comprises class labels. In some embodiments it also outputs the locations of detected fluid containers. Embedded system 112 sends controlling signals to a switching circuit 115 to operate valve 104 in response to the outputs. An opening signal closes the switching circuit and opens the valve. A switching circuit is typically built around one (for example I used the switching circuit in (Chris@BCR, Jul. 2, 2015)) or more transistors (for example in the operational amplifier), it usually also include other components such as capacitors, diodes, etc. These transistor(s) and components are configured to allow controlling using one or more digital signals, a current to pass from a separate source to the fluid valve where the current is much bigger than that the embedded system can output by itself. In some embodiments the opening signal is required to be maintained as a level in order for the controlled fluid valve to remain open, and either the low or the high voltage can be defined as the opening signal. In some other embodiments, a first pulse signals opening and then a second one signals closing.

In some embodiments, a sequence labeling unit comprises a convolutional neural network for classification. A convolutional neural classification network typically comprises multiple convolutional, activation, and pooling layers followed by one or more fully connected layers and an output layer. One of the earliest convolutional neural network is (Lecun, Bottou, Bengio, & Haffner, 1998), and many variations has been proposed since then. A convolutional layer convolutes tiles at different locations from its input with a convolution kernel. Layer hyper parameters include for example strides, kernel sizes, and padding, etc. An activation layer applies a nonlinear activation function to its inputs. Examples of activation layers include RELU, tahn, sigmoid, etc. A pooling layer reduces the size of its inputs by locally sampling its inputs, examples include max pooling, L2-norm pooling, average pooling, etc. A fully connected layer comprises multiple artificial neurons, where each neuron receives input from every element of the previous layer and outputs a linear transformation. An output layer typically composes a software max or sigmoid layer, but other suitable nodes can also be applied. Other layers including normalization layers, drop-out layers are sometimes also included, and if drop-out layers are included they are typically only included during training. Model parameters such as the convolution kernels and the weights of the fully connected layers are learned during training: typically a gradient based methods such as the stochastic gradient descent method or the mini-batch gradient descent method is used to gradually drive down a cross-entropy loss function, where parameter updates are propagated backwards with the back propagation algorithm.

Training is typically done on desktops or servers equipped with specialized coprocessors like GPUS or TPUs but with a lot more computation power than those found in embedded systems. Even so, training a non-trivial neural network typically involves a large amount of time and computing resources. Because of this, transfer learning is popular among practitioners. Transfer learning comprises grabbing a trained neural network, retaining most of the earlier layers comprising lower level features, and retraining only the last few layers with custom training images for object recognition or detection. This is the approach I took in my experiments. For the convolutional neural network, I retrained a GoogLeNet network using images of fluid containers as described below, but alternative convolutional neural networks such as VCG, ResNet, or a customized one could also be used. Later, for the object detection neural network, I retrained a “ssdlite_mobilenet_v2_coco_2018_05_09” neural network.

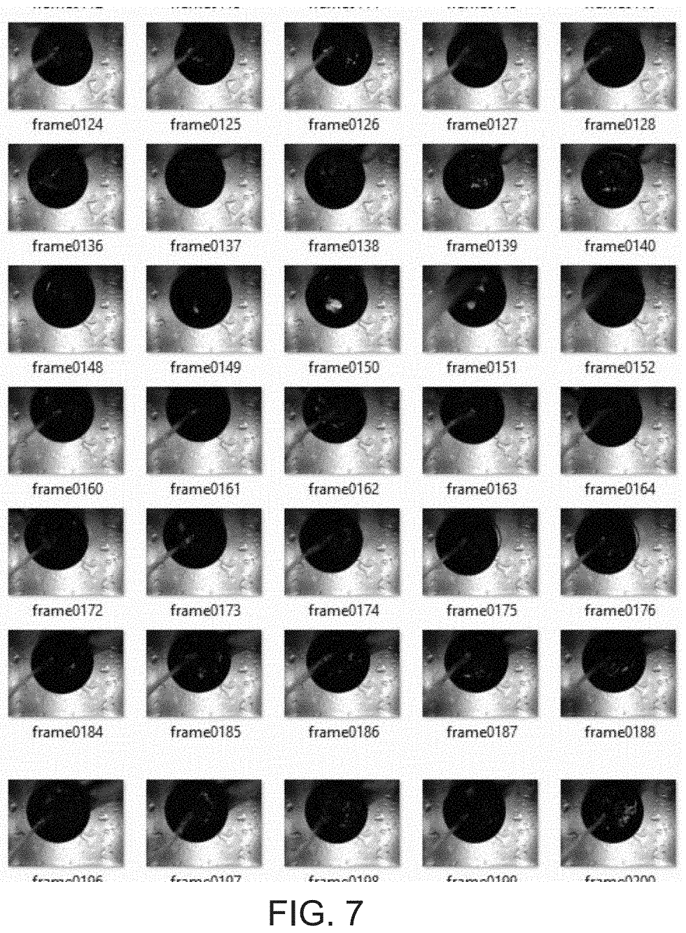

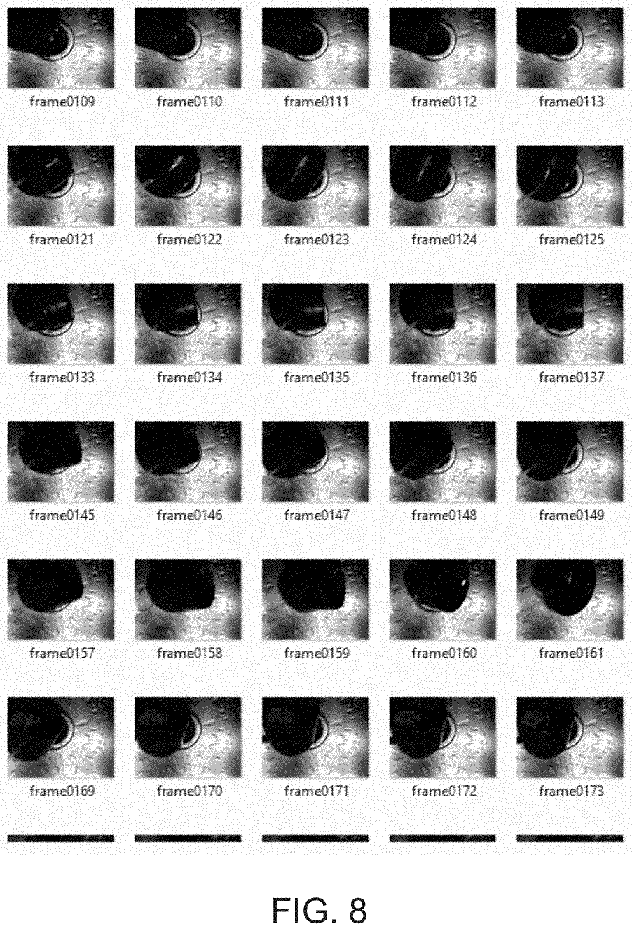

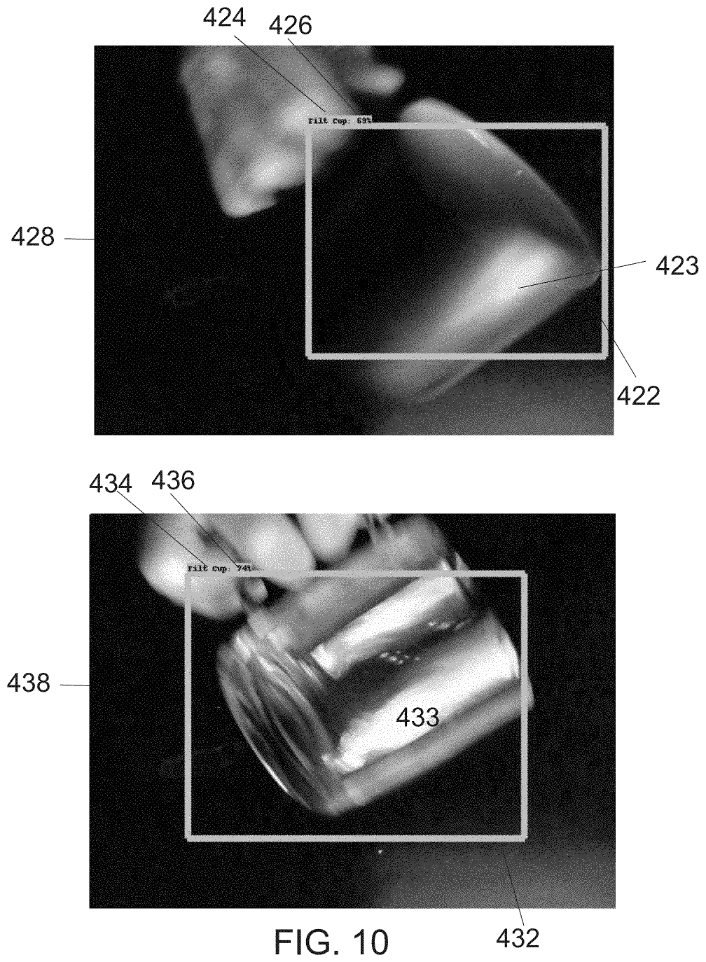

For my experimentation, first I move a fluid container around under an overlooking camera, keeping changing its position and orientation while recording. Similar processes are repeated both when fluid is being dispensed, and when fluid is not being dispensed. For experimenting purpose, I collected about 1800 images for this fluid container. For a production system there need to be more images, and possibly for various types of fluid containers under different lighting conditions too if they are not controlled in working environments. I then manually inspected the images and labeled each of them into one of four classes: “receiving” (examples shown in FIG. 9), meaning that the image shows a fluid container positioned to receive fluid; “off center” (examples shown in FIG. 8), in this case the images shows a fluid container but it's not positioned to receive fluid; “tilting” (examples shown in FIG. 10), meaning that the image shows a container put in a receiving area, but not oriented correctly, e.g. side ways or even upside down; and “not present” (examples shown in FIG. 7), meaning the image is not showing a fluid container, or only a small portion. In this case labeling involves moving the images into four directories corresponding to the four classes. These images are also divided into a training set and a testing set.

Alternative classification schemes could be used. For example the three classes: “off center”, “tilting”, and “not present” can be merged into a “not receiving” class. Then we'll be training the network using only two output classes. As a result, the embedded system turns off the solenoid valve if the output changes from “receiving” to “not receiving”, and turns on the valve if the output changes from “not receiving” to “receiving”.

In some embodiments, a label filter is used to improve accuracy. A simple example of a label filter is a counting unit. For example, if the frequency is about 10 Hz, and if four out of five of the lastly processed images suggest a receiving fluid container, then a filtered class label is computed corresponding to a label indicate “receiving”. Vice versa if four out of five of the lastly processed images suggest not receiving. In practice these numbers need to be tuned based on factors such as the accuracy and speed of classification.

Alternatively suitable time series filters can be used after numericalizing the class labels. For example if a Moving Average Filter is used, a number “1” can be assigned to each class label corresponding to a receiving fluid container, and “0” otherwise. I call this “binary numericalizing”. The embedded system computes a moving average for the last predefined number of frames, and a filtered class label is computed according to whether the moving average is above or below a predetermined threshold. As another example, a Recurrent Neural Network (RNN) comprising multiple RNN cells is used, where each of the RNN cells comprises a hidden state. The input could comprise the numericalized output class label computed by the convolutional neural network, or even the scores output by the Softmax layer. At each time step, it updates the hidden states using the hidden states from the previous time step and the current input. An output layer can be used on top of the RNN cells to output a filtered class label. The label filters described here can also be used to filter the labels generated by an object detection neural network that we'll describe later.

In some other embodiments, a sequence labeling unit comprises an object detection neural network. Various object detection neural network architectures have been proposed, examples include R-CNN, Fast R-CNN, Faster R-CNN, YOLO, etc. A popular one is the Single Shot MultiBox Detector (SSD) introduced in (Liu et al., 2016). An SSD comprises a base network similar to a convolutional neural network without the fully connected and output layers. It then adds multiple convolutional feature layers of decreasing sizes for matching at different scales. Each feature layer outputs a feature map, and a predetermined set of bounding boxes with different sizes and aspect ratios are defined for pixels on the feature map. Convolutional feature layers of different scales are connected to a detection layer comprising prediction kernels, some of which output scores for classification, and others output coordinate offsets relative to the associated bounding boxes. Each prediction kernel is associated with one of the feature maps. A last non-maximum suppression layer suppresses detections whose scores are below a predetermined threshold. Model parameters such as the kernels of the additional feature layers and the detection layer are trained with back-propagation and an objective function comprising localization loss and confidence loss.

Similar to convolutional neural networks, transfer learning is often applied to training SSDs. However the input and the output are different. For training an SSD, images are annotated with labeled ground-truth boxes surrounding each object-of-interest. The outputs includes the coordinates of bounding boxes surrounding detected objects, their class labels, and confidence scores that can be used to discard low confidence detections. In other words, when a convolution neural network for classification is used, the output class label encodes both the location and the orientation; when an object detection neural network is used, the output class label encodes the orientation and the output coordinates indicates the position of an observed fluid container.

Google's Tensorflow Object Detection API includes implementations of various SSD models. The API also provides various helper scripts and examples, and that's what I experimented with. Alternatively other frameworks such as NVIDIA's DIGITS and the Open Source Community's PyTorch and Caffe can also be used. For experimenting purpose, I collected about 1400 images each of them showing one of a few different containers with different poses or no containers, where by pose we mean position and orientation. For a production system one need to collect more. I manually inspected each image and draw bounding boxes around fluid containers that I saw, except for those that show only a small portion. Each bounding box is labeled as one of two classes: “Up Cup”, meaning that the fluid container is shown with its mouth facing about upwards; and “Tilt Cup”, meaning the fluid container is shown not oriented upwards, for example side ways or even upside down. I didn't use the previously mentioned “off center” or “not present” classes because of the availability of the coordinates. As described earlier, this classification scheme is not meant to be fixed. For example in some other embodiments the “Tilt Cup” class can be divided into multiple classes such as “Tilt Sideways” and “Tilt Upside Down”. I then retrained a “ssdlite_mobilenet_v2_coco_2018_05_09” model on a desktop machine with an NVIDIA Geforce 970 GPU. Here's a summary of the steps for training models using the Tensorflow Object Detection API following (Santos, May 13, 2018):

1. Collect overlooking images;

2. preprocess collected images;

3. split the images into a training and a testing set;

4. annotate images with labeled bounding boxes;

5. generate TFRecord;

6. creating a label map;

7. create a pipeline file; and

8. train the model by invoking a script “train.py”.

These steps should be more or less common among different frameworks, although different frameworks may have different file formats, different APIs to call and different scripts to invoke. Also the order of some of the steps can be changed. For example, in the tutorial cited above, the author annotated collected images before splitting them into a training and a test set. The Tensorflow Object Detection API provides an example of loading and using a trained SSD model in a python notebook “object_detection_tutorial.ipynb”. One can modify the code to suit one's own needs. FIGS. 9 and 10 show some results. Referring to FIG. 9, it illustrates two exemplary detections of the “Up Cup” class. Image 408 shows a bounding box 402 surrounding a cup 403, it has a classification 404 of “Up Cup”, and a confidence score 406 of 76%. Image 418 shows a bounding box 412 surrounding a cup 413, it has classification 414 of “Up Cup”, and a confidence score 406 of 75%. Referring to FIG. 10, it illustrates two exemplary detections corresponding to the “Tilt Cup” class. Image 428 shows a bounding box 422 around a cup 423, it has a label 424 of “Tilt Cup”, and a confidence score 426 of 69%. Image 438 shows a bounding box 432 surrounding a cup 433, it has a label of “Tilt Cup”, and a confidence score 436 of 74%. Generating these images are visualizations of the results of the SSD that can be used for tuning and debugging, but not necessarily present in a working system.

For some embodiments, where a sequence labeling unit comprises an object-detection neural network, a spatial filter could be implemented in the sequence labeling unit to track the locations of observed fluid containers. For example in some embodiments a Kalman Filter is used. The state variables are (x,y,vₓ,v_{y})^{T}, where x,y are the filtered coordinates of the center of an observed fluid container, and vₓ,v_{y} are the estimated velocities in both directions, the system and measurement modes are

$$A = [ \begin{matrix}1 & 0 & Δ t & 0 \\ 0 & 1 & 0 & Δ t \\ 0 & 0 & 1 & 0 \\ 0 & 0 & 0 & 1\end{matrix} ] , H = [ \begin{matrix}1 & 0 & 0 & 0 \\ 0 & 1 & 0 & 0\end{matrix} ]$$

As new observations of (\hat{x},ŷ) (which can be computed from the coordinates of the four corners of a bounding box) keep coming in, it repeatedly generates predictions, and estimates new values for the state variables using the predictions and the new observations. Other suitable space filters can also be used. For example, since the classic Kalman Filter is based on normal distributions, variations such as the Uncented Kalman Filter was developed to cope with other distributions, but they can also be used with normal distributions. A particle filter approximates a distribution using a set of particles where each particle has a weight called the importance weight. It repeatedly generates predictions for particles, update the particles' importance weights using the observations and the predictions and resamples the set of particles.

FIG. 12 shows an exemplary sequence labeling unit 522, it comprises an object detection neural network for inferencing 524, a spatial filter 526, and a label filter 528. As described earlier, the spatial filter could be a Kalman filter or other suitable filters, and the label filter could be a counting unit or other suitable filters.

FIG. 3 is a side view of some inner components of an exemplary fluid dispenser comprising another embodiment of this invention. A fluid valve 134 is mounted inside a fluid dispenser 130. Valve 134 has an inlet 132 that is connected through pipe 131 to some fluid source (not shown), and an outlet 136 that is connected to a pipe 138. Pipe 138 is connected to a tube 139 that is connected to a spout 140. fluid flows into inlet 132 with a certain pressure so that it can flow through valve 134, outlet 136, pipe 138, tube 139, and spout 140 when valve 134 is turned on, and it is suspended when valve 134 is turned off. For illustration purpose, FIG. 3 also shows a fluid container 146 placed on a base 148 beneath spout 140 so that it can receives fluid 150. A embedded system 142 is mounted inside the drink dispenser. Embedded system 142 receives overlooking images from an overlooking camera 144 mounted at the corner of pipe 139 and a vertical supporting surface 145. Embedded system 142 runs a sequence labeling unit 141, and Embedded system 142 operates valve 134 through switching circuit 135.

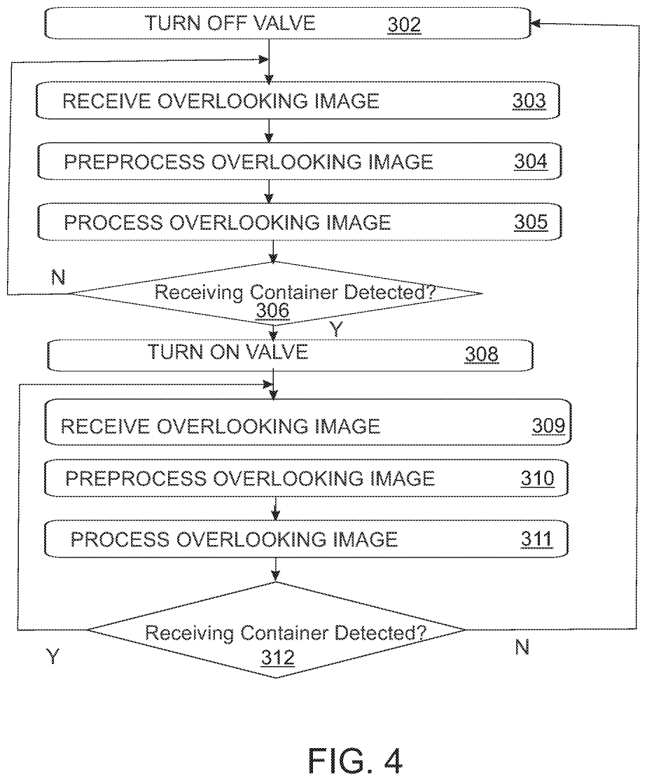

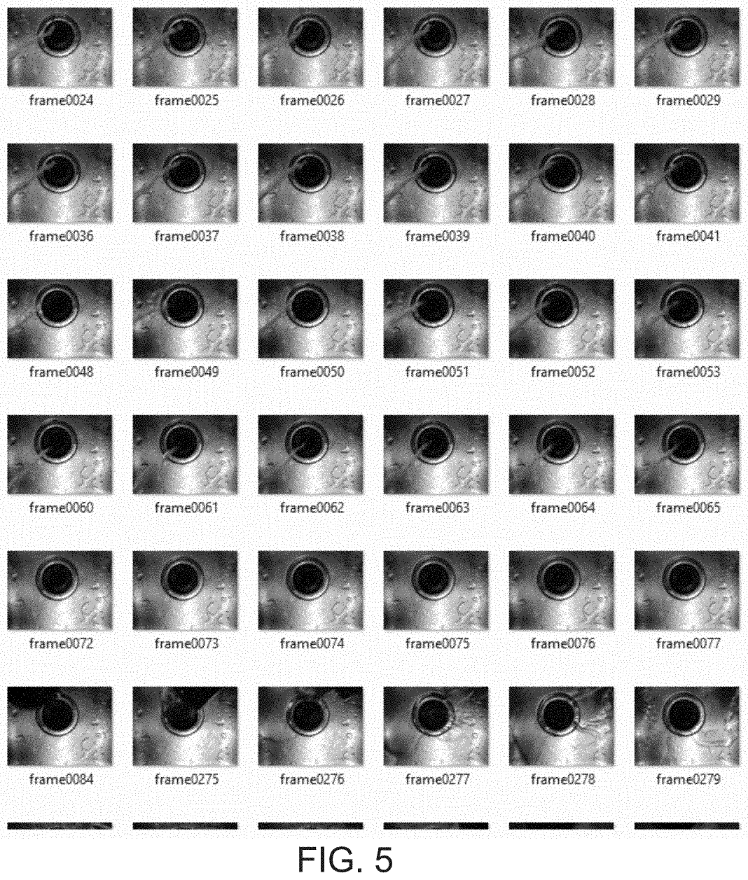

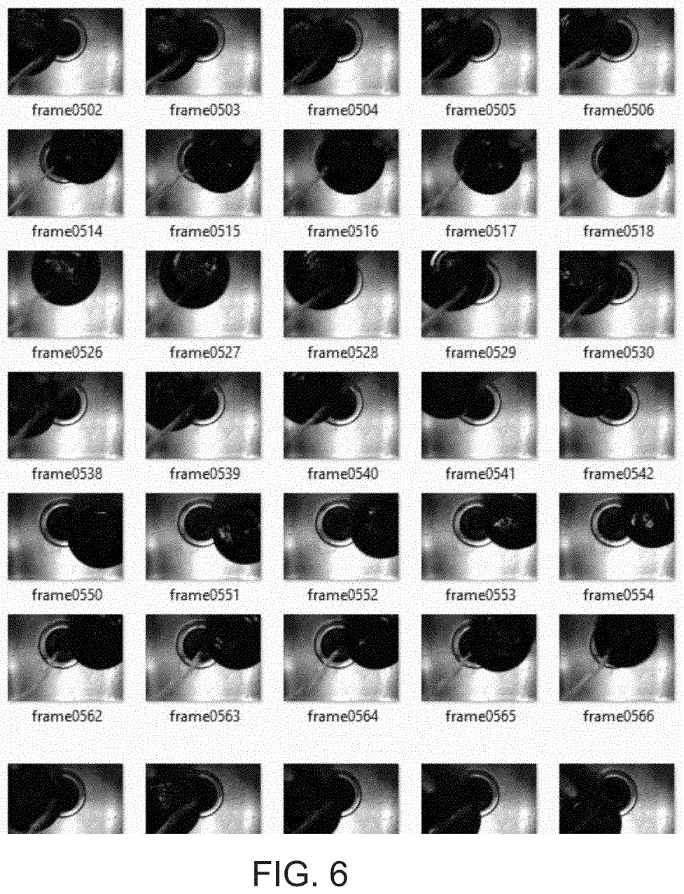

FIG. 4 is a flow chart illustrating the steps for automatic fluid dispensing according to one embodiment. At step 302, the fluid valve is off. At step 303, the embedded system receives an overlooking image from a connected overlooking camera. If overflowed by overlooking images, the embedded system shall prioritize more recently received images and discard earlier ones. At step 304, the embedded system preprocesses the overlooking image and at step 305 it processes the image with the sequence labeling unit.

At step 306, if a convolution neural network for classification is used, the output class label encodes both the location and the orientation. The embedded system compares the output class label. If it corresponds to a receiving container, then at step 308 the embedded system sends an opening signal to a connected switching circuit at step 308 to direct a controlled valve to start to dispense fluid; otherwise it returns back to step 303 and the valve remains closed. If an object detection neural network is used, the output class label encodes the orientation and the output coordinates encodes the position of an observed fluid container. The embedded system examines both the output class label and the output coordinates, checking whether the output class label corresponds to a fluid container in a receiving orientation, meaning its mouth is about upwards, and whether the output coordinates indicates that the container is at a receiving area.

There are various ways to check whether output coordinates indicate that a fluid container is at a receiving area. For example, using a spatial filter as described above, one can filter the coordinates corresponding to the center of the container, then compute the distance between this filtered center and a predetermined location on the image representing the location of the spout and compare the distance to a predetermined threshold. As another example, one can filter the four corners' coordinates, and check whether a predetermined location on the image representing the location of the spout falls into a virtual box that's embedded within the virtual box formed by the four filtered corners by a predetermined amount. In yet another example, one can filter the center's coordinates, the widths and heights of the observed bounding boxes and check whether a predetermined location on the image corresponding to the location of the spout falls into a virtual circle that's embedded within the virtual circle passing the four corners, or really three will suffice, computed from the filtered center, width, and height by a predetermined amount.

Once it starts to dispense fluid at step 308, at step 309, the embedded system continue to receive overlooking images from the overlooking camera. At step 310 and 311, it continue to preprocess and process the overlooking image, except that at step 312, if the fluid container is no longer receiving, it goes back to step 302 by sending a closing signal to the switching circuit, otherwise it goes back to step 309.

The drawings are provided as examples. That is, besides what's being shown in the drawings, units may be mounted at other suitable locations, units may be combined, sub-units may be organized in different ways, or parent units may be expanded to include additional units without distracting from the essence of the disclosed embodiments.

### REFERENCES

Chris@BCR. (Jul. 2, 2015). Controlling a solenoid valve with arduino. https://www.bc-robotics.com/tutorials/controlling-a-solenoid-valve-with-arduino/. (Accessed: 2019-02-13)
Lecun, Y., Bottou, L., Bengio, Y., & Haffner, P. (1998, November). Gradient-based learning applied to document recognition. Proceedings of the IEEE, 86(11), 2278-2324. doi: 10.1109/5.726791
Liu, W., Anguelov, D., Erhan, D., Szegedy, C., Reed, S., Fu, C.-Y., & Berg, A. C. (2016). Ssd: Single shot multibox detector. In B. Leibe, J. Matas, N. Sebe, & M. Welling (Eds.), Computer vision—eccv 2016 (pp. 21-37). Cham: Springer International Publishing.
Santos, J. D. D. (May 13, 2018). Detecting pikachu in videos using tensor4ow object detection. https://towardsdatascience.com/detecting-pikachu-in-videos-using-tensorflow-object-detection-cd872ac42c1d. (Accessed: 2018-12-12)

I claim:

1. A system for automatic fluid dispensing, comprising:
a fluid valve that is electrically operable, said valve includes an outlet port for delivering fluid that's connected to an output spout, and an inlet port that is connected to a fluid source so that fluid can flow through said valve when it is turned on, and suspends when said valve is turned off;
an overlooking camera configured to take overlooking images;
a switching circuit configured to operate said valve given input digital signals;
an embedded system including a sequence labeling unit, said embedded system is operatively connected to said overlooking camera and said switching circuit, wherein said embedded system is configured to receive an overlooking image from said overlooking camera, preprocess said overlooking image, use said sequence labeling unit to process said overlooking images to decide if a fluid container is ready to receive, and send a corresponding digital signal to said switching circuit.

2. The system in claim 1, wherein said sequence labeling unit comprises a convolutional neural network for classification configured to classify said overlooking image to generate a class label, wherein said embedded system is configured to compare said class label for indicating whether a fluid container is ready to receive.

3. The system in claim 2, wherein said sequence labeling unit further comprises a label filter, wherein said sequence labeling unit is configured to process a plurality of said overlooking images to generate a plurality of class labels and said label filter is configured to filter said plurality of class labels to generate a filtered class label, wherein said embedded system is configured to compare said filtered class label for indicating if said fluid container is ready to receive.

4. The system in claim 3, wherein said embedded system is configured to apply a predetermined perspective transformation to said overlooking image, and convert the color space of said overlooking image.

5. The system in claim 3, further comprising an overlooking light.

6. The system in claim 1, wherein said sequence labeling unit comprises an object detection neural network configured to detect the orientation and the location of a fluid container in said overlooking image, generate a class label for said orientation and coordinates for said location, wherein said embedded system is configured to compare said class label for indicating if said fluid container is with a receiving orientation, and comparing said coordinates for indicating if said fluid container is present at about a predetermined receiving area.

7. The system in claim 6, wherein said embedded system is configured to apply a predetermined perspective transformation to said overlooking image, and convert the color space of said overlooking image.

8. The system in claim 6, wherein said sequence labeling unit further comprises a label filter, wherein said sequence labeling unit is configured to process a plurality of said overlooking images to generate a plurality of class labels and said label filter is configured to filter said plurality of class labels to generate a filtered class label, wherein said embedded system is configured to compare said filtered class label for indicating if said fluid container is with a receiving orientation.

9. The system in claim 8, wherein said label filter comprises a counting unit.

10. The system in claim 6, wherein said sequence labeling unit further comprises a spatial filter, wherein said sequence labeling unit is configured to process a plurality of said overlooking images to generate a plurality of coordinates, and filter said plurality of coordinates with said spatial filter to generate filtered coordinates, wherein said embedded system is configured to compare said filtered coordinates for indicating if said fluid container is at a predetermined receiving area.

11. The system in claim 10, wherein said spatial filter comprises a Kalman Filter.

12. The system in claim 6, wherein said sequence labeling unit further comprises a label filter and a spatial filter, wherein said sequence labeling unit is configured to process a plurality of said overlooking images to generate a plurality of class labels and a plurality of coordinates, filter said plurality of coordinates with said spatial filter to generate filtered coordinates, and filter said plurality of class labels with said label filter to generate a filtered class label, wherein said embedded system is configured to compare said filtered class label for indicating if said fluid container is with a receiving orientation, and compare said filtered coordinates for indicating if said fluid container is at a predetermined receiving area.

13. The system in claim 12, wherein said embedded system is configured to apply a predetermined perspective transformation to said overlooking image, and convert the color space of said overlooking image.

14. The system in claim 12, wherein said fluid valve is a solenoid valve.

15. The system in claim 12, further comprising an overlooking light.

16. A method for automatic fluid dispensing, comprising:
providing a solenoid valve that is electrically operable, wherein the inlet port of said valve is connected to a fluid source so that fluid can flow through said valve when it is turned on, and suspends when said valve is turned off, and the outlet port of said valve is connected to a spout;
providing an overlooking camera for taking overlooking images;
providing a switching circuit that is operatively connected to said valve for operating said valve given input digital signals;
providing an embedded system with a sequence labeling unit, wherein said embedded system is operatively connected to said overlooking camera for receiving overlooking images, and said embedded system is operatively connected to said switching circuit for operating said valve;
receiving an overlooking image from said overlooking camera in said embedded system;
preprocessing said overlooking image with said embedded system, comprising applying a predetermined perspective transformation to and converting the color space of said overlooking image;
processing said overlooking image with said sequence labeling unit;
deciding if a fluid container is ready to receive;
sending a corresponding digital signal to said switching circuit;
providing an overlooking light.

17. The method in claim 16, wherein said sequence labeling unit comprises a convolutional neural network for classification, wherein said processing an overlooking image comprises classifying said overlooking image to generate a class label using said sequence labeling unit, wherein said deciding if a fluid container is ready to receive comprises comparing said class label for indicating whether a fluid container is ready to receive.

18. The method in claim 17, wherein said sequence labeling unit further comprises a label filter, wherein said processing an overlooking image comprises processing a plurality of said overlooking images with said object detection neural network to generate a plurality of class labels and filtering said plurality of class labels with said label filter to generate a filtered class label, wherein said comparing said class label comprises comparing said filtered class label for indicating if said fluid container is with a receiving orientation.

19. The method in claim 16, wherein said sequence labeling unit comprises an object detection neural network, wherein said processing an overlooking image comprises detecting the location and orientation of a fluid container using said object detection neural network, and generating a class label for said orientation and coordinates for said location, wherein said deciding if a fluid container is ready to receive comprises comparing said class label for indicating if said fluid container is with a receiving orientation, and comparing said coordinates for indicating if said fluid container is at a predetermined receiving area.

20. The method in claim 19, wherein said sequence labeling unit further comprises a label filter and a spatial filter, wherein said processing an overlooking image comprises processing a plurality of said overlooking images with said object detection neural network to generate a plurality of class labels and a plurality of coordinates, filtering said plurality of class labels with said label filter to generate a filtered class label, and filtering said plurality of coordinates with said spatial filter to generate filtered coordinates, wherein said comparing said class label comprises comparing said filtered class label for indicating if said fluid container is with a receiving orientation, and said comparing coordinates comprises comparing said filtered coordinates to the location of said output spout for indicating if said fluid container is at a predetermined receiving area.

21. The method in claim 20, wherein said label filter comprises a counting unit and said spatial filter comprises a Kalman Filter.

22. The method in claim 16, wherein said embedded system comprising a coprocessor.
